(19) United States
(12) Patent Application Publication
(10) Pub. No.: US 2019/0095970 A1
(43) Pub. Date: Mar. 28, 2019

(54) SYSTEM AND METHOD FOR DATE AND CULTURE BASED CUSTOMIZABLE CARDS FOR MULTIFUNCTION PERIPHERALS

(71) Applicants: Kabushiki Kaisha Toshiba, Minato-ku (JP); Toshiba TEC Kabushiki Kaisha, Shinagawa-ku (JP)

(72) Inventor: Milong SABANDITH, Irvine, CA (US)

(21) Appl. No.: 15/714,576

(22) Filed: Sep. 25, 2017

(51) Int. Cl. G06Q 30/06; H04N 1/00; H04N 1/32; H04N 1/34; G06Q 20/12; G06Q 20/34; G06Q 50/00

(52) U.S. Cl. CPC G06Q 30/0621; H04N 1/00411; H04N 1/00344; H04N 1/00225; H04N 1/00233; H04N 1/00461; G06F 3/04842; H04N 1/32117; H04N 1/342; G06Q 20/12; G06Q 20/3558; G06Q 50/01; H04N 1/00466

(57) ABSTRACT

A system and method for generating culturally appropriate customizable cards on multifunction peripherals includes a touchscreen user interface that displays customizable cards that can be selected and customized by users. A processor generates an electronic image of a customized card, and a document processing engine of the multifunction peripheral renders printed output from the electronic image. The multifunction peripheral sends identifying information to a card template server that provides culturally relevant customizable card templates to the multifunction peripheral based on an identified culture associated with the users of the multifunction peripheral, the geographic region where the multifunction peripheral is located, and the date.

### TECHNICAL FIELD

This application relates generally to multifunction peripherals capable of presenting users with a variety of cards that can be customized and output via a multifunction peripheral. This application relates more particularly to a multifunction peripheral that offers users culturally relevant customizable cards based on the date and the location of the multifunction peripheral.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

MFPs are essential business tools it a modern office environment. Earlier devices employed discrete mechanical switches or buttons for user device control. As MFPs became more powerful and configurable, device control was accomplished by an on-board computer referred to as an intelligent controller. A controller can be programmed to control MFP functions such as scanning, printing, or copying. A copying operation could be accomplished by controlling the scanner and printer sequentially. Controllers could also function to enable additional device functions such as stapling or hole punching. Increased device functionality lead to a menu driven, touchscreen user interface to enable a user to easily configure an MFP to accomplish a desired document processing job.

Consumers often purchase greeting cards for friends and family. Often these cards are purchased for events specific to the user's culture, for example Valentine's Day, Christmas, and so forth. Consumers also purchase gift cards and vouchers that may be inserted into greeting cards. Consumers can also purchase electronic versions of greeting cards and gift cards. If the consumer desires to give a physical card, the consumer must often travel to a store to find and purchase an appropriate card for the occasion.

### SUMMARY

In accordance with an example embodiment of the subject application, a system and method for generating culturally appropriate customizable cards on multifunction peripherals includes a document processing engine for rendering printed output from electronic image files. A touchscreen user interface on displays customizable cards that a user can select and customize. A processor generates an electronic image of the customized card and the document processing engine prints the customized card. A card template server receives identifying information from MFPs and provides culturally relevant customizable card templates to the MFPs based on identified cultures, regions, and the date.

### BRIEF DESCRIPTION OF THE DRAWINGS

Various embodiments will become better understood with regard to the following description, appended claims and accompanying drawings wherein:

FIG. 1 an example embodiment of a multifunction peripheral for generating culturally relevant customizable cards;

FIG. 2 is an example embodiment of a user interface depicting a graphical rendering of an example customizable card generation system on an MFP display;

FIG. 3 is an example embodiment of a user interface screen depicting a virtual keyboard;

FIG. 4 is a flowchart an example embodiment of operations for generating culturally relevant customizable cards on multifunction peripherals; and

FIG. 5 is a functional block diagram of an example embodiment of a multifunction peripheral.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MFPs are powerful and essential business tools. User interaction is straightforward and accomplished with touchscreen menus that are solely geared toward accomplishing a typical document processing operation, such as scanning, printing or copying. While functional, touchscreen device interfaces can be unengaging for users, particularly when a user uses a device regularly for the same or similar tasks.

The subject application teaches example embodiments of MFPs that provide culturally appropriate card templates based on the date and region that can be customized by users and outputted by the MFP. A customizable card creation system provides a service that makes MFPs more useful to end users, helps content providers to monetize their premium content, generates additional revenue for companies that lease MFPs, and can even offset part of the cost of leasing MFPs.

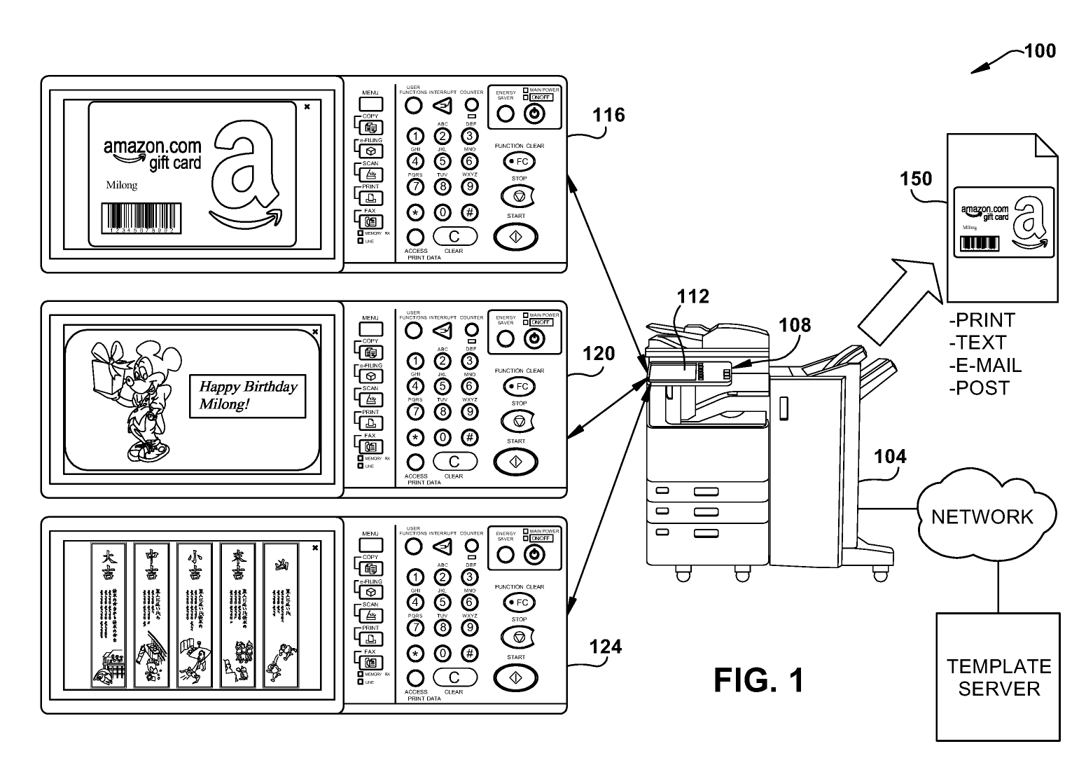

In accordance with the subject application, FIG. 1 In accordance with the subject application, FIG. 1 illustrates an example embodiment of a customizable card generating system 100 running on MFP 104. MFP 104 includes a user interface 108 including a touchscreen 112 configured to display graphical images and text, and suitably programmable to allow for numeric or text entry, for example using a virtualized or soft keyboard. In operation, the MFP 104 queries a template server 130 for customizable cards that are offered to users through a suitable menu system. Users can select a customizable card, customize the card using the touchscreen 112, and output a customized card 150 for example by printing the card on the MFP 104.

The MFP 104 accesses the template server 130 via a suitable local network or wide area network which can include the Internet 134 as shown. The template server 130 is configured to provide culturally relevant customizable cards to the MFP 104 based on the date, the general region where the MFP 104 is located, and any other suitable culturally relevant information provided. The MFP 104 can be configured to periodically verify the correct local time and date for the MFP 104, for example by contacting an NTP (network time protocol) server. In a configuration, the template server 130 can determine the correct date and time for the MFP 104. In a configuration, the MFP 104 can provide the template server 130 with region and other culturally relevant information. In another configuration, the template server 130 can determine the region associated with the MFP 104, for example by examining the IP (internet protocol) address of the MFP 104, for example in conjunction with local date and time information provided by the MFP 104.

The template server 130 stores templates of customizable cards. The customizable cards can include greeting cards, holiday cards, anniversary cards, cards associated with specific religious events, gift cards, calendars, and so forth. The templates can be organized or tagged so that the appropriate types of customizable cards are sent to the MFP 104 based on the date, the region, and other culturally significant information available to the template server 130 about the MFP 104 and its users.

Templates for customizable cards can include text, graphics, moving graphics, emoji, video, and game elements as would be understood in the art. The templates can include premium art that can be virtually indistinguishable from professional cards when printed on a suitable MFP 104. For example, a day before and on Valentine's Day itself, the template server 130 can transmit Valentine's Day templates to the MFP 104. A husband or wife can quickly print a customized and professional looking card directly from the MFP 104 at his or her workplace without needing to visit a store to find a suitable card for their spouse. The template server can include premium content by partnering with companies such as HALLMARK and AMERICAN GREETINGS, or other well-known brands. Companies can be required to pay to have their customizable cards promoted by the template server 130 and sent to MFPs 104. Premium content can be made available for a surcharge as described below, and can include brand elements and copyright protected elements as would be understood in the art.

The template server 130 can update templates sent to an MFP 104 daily, or periodically, to encourage customer interaction, and can charge rent to content providers seeking to promote their customizable cards. For example, AMAZON may be required to pay a royalty for each AMAZON gift card that is purchased on an MFP 104 based on the value added to each gift card. Advantageously, the customizable card creation system 100 allows companies to reach more consumers, as consumers can purchase cards from the convenience of the user's workplace. The customizable card creation system 100 also saves the end users time and effort in generating and sending cards, as they no longer are required to visit a store to obtain a suitable card. Moreover, the cards can be personalized with the recipient's name before they are printed. The customizable card creation system 100 makes the MFP 104 more useful to the end user, and results in more use of this resource. Companies that lease MFPs 104 benefit from the additional print copies generated by users using the customizable card creation system 100, as they are typically paid based on the number of printed copies. Costs to companies leasing the MFPs 104 can be offset by revenues generated by the sale of premium content.

In the illustrated example embodiment, three example user interface renderings 116, 120, and 124 of the customizable card creation system 100 are presented. In interface rendering 120, an example customizable birthday card, which includes premium content from the DISNEY company, is presented. In interface rendering 124, example Japanese Omikuji can be presented during certain times of the year to MFPs 104 in Japan, or MFPs 104 located at Japanese companies outside of Japan. Japanese Omikuji are random fortunes written on strips of paper at Shinto shrines and Buddhist temples in Japan. Meaning “sacred lot,” these are usually received by making a small offering and randomly choosing one from a box, hoping for the resulting fortune to be good. The customizable card of interface rendering 124 can be suitably configured to provide an omikuji-like user experience to a recipient.

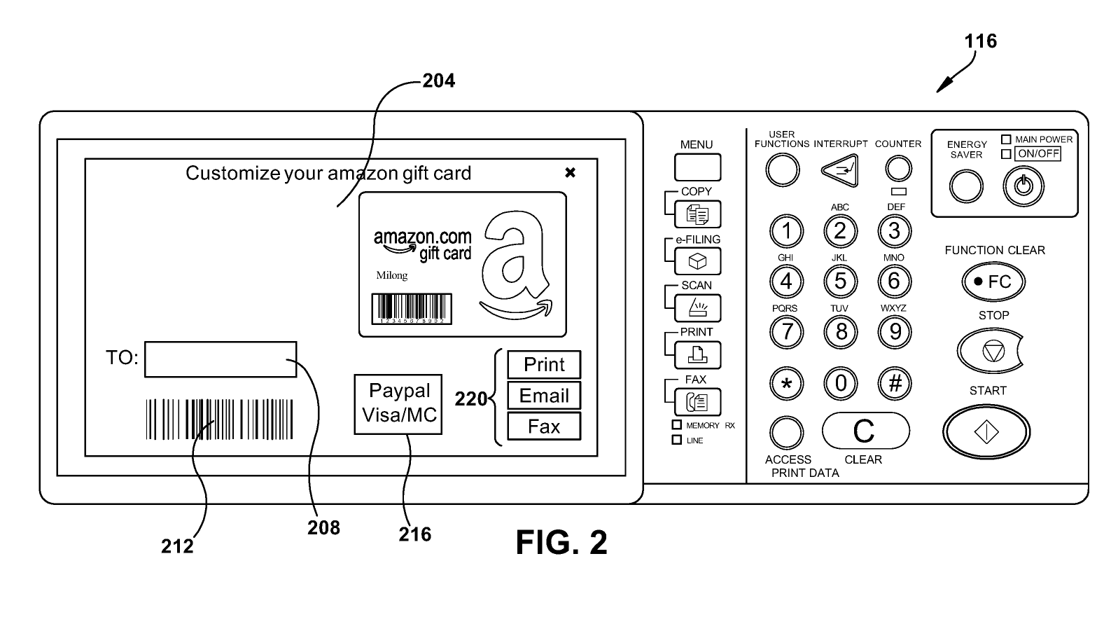

In interface rendering 116, an example customizable AMAZON gift card is illustrated, with added reference to FIG. 2, which includes a graphical representation of the customizable card 204. For example, the customizable card 204 can be an AMAZON gift card as illustrated. The customizable card 204 can include an entry box 208 where the recipient's name can be entered. The customizable card 204 can include features specific to the type of customized card 204. For example, an AMAZON gift card can include a payment button 216 that allows value to be added to the customized card 204. Once value has been added, the AMAZON code associated with the value can be added, which can include a barcode 212 or any other suitable information, including be not limited to a unique set of characters for redeeming the value stored on the AMAZON gift card. When finalized, the user can output the customizable card 204 via a suitable output selection 220. For example, a customizable card 204 can printed using the MFP for hand delivery to the recipient, or an electronic version of the customizable card 204 can be sent electronically via email, or fax. Some options may be unavailable, based on license restrictions on the content, for privacy reasons, or to prevent accidental disclosure of redeemable gift cards. For example, an option for posting the card to one or more social media sites can be enabled if the customizable card 204 is suitable for public viewing.

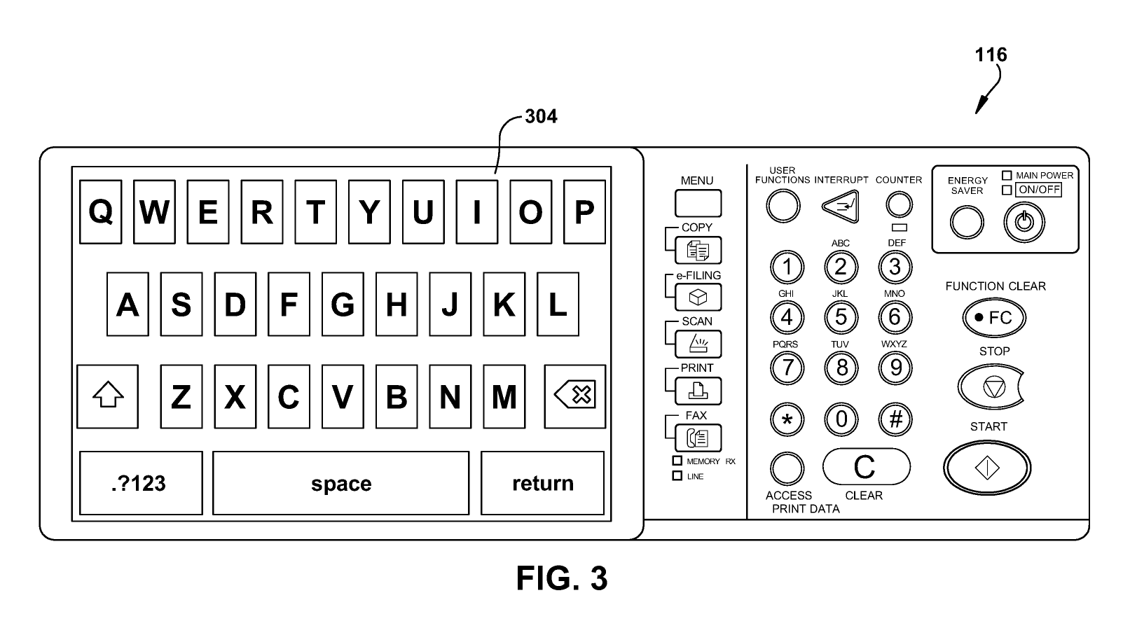

Referring additionally to FIG. 3, in interface rendering 116 the user can enter customized information, for example recipient information and billing information, using a pop-up virtual keyboard 304. Other suitable information means for entering appropriate information can be used, such as looking up the recipient information using an address book or the like.

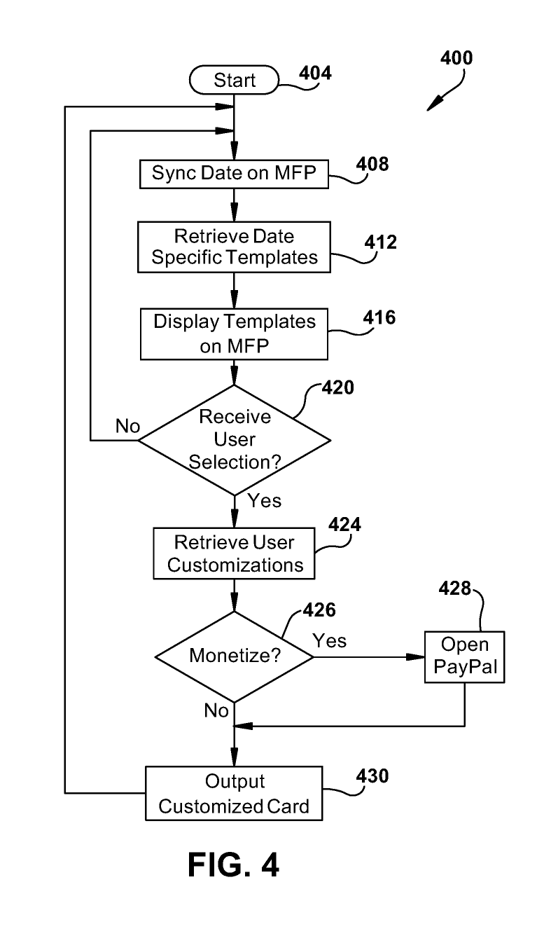

Referring next to FIG. 4, illustrated is a flowchart 400 of example operations for accomplishing the forgoing on an MFP by use of its associated controller. The process commences at block 404 with an application launch, after which the MFP synchronizes its time and date for example through network communications with an NTP (network time protocol) server or a local server at block 408. The MFP retrieves card templates from a template server at block 412. The MFP can provide the template server with information such as the local time and date for the MFP, as well as the location or region of the MFP, and any other culturally relevant information. For example, if the MFP is used by a particular house of worship, the culturally relevant information may include the religion and denomination associated with that house of worship. Such culturally relevant information can aid the template server in providing only templates that might reasonably be used by the users of a particular MFP. In a configuration, the template server 130 can determine the geographical region of the MFP based on IP address and verify the geographical region based on the date and local time provided by the MFP.

The MFP displays one or more customizable card templates retrieved from the template server at block 416. The customizable card templates can be displayed in a suitable menu system and can generate pop-up windows or other suitable types of user notifications. If the MFP receives a user selection of one of the card offers at block 420, then processing continues to block 424, otherwise processing returns to process block 408. At block 424, the user can customize the card. For example, the user can personalize the card by adding the name of the intended recipient. Other customized information can include, but is not limited to, the recipient's email address or mailing address, a personalized message, or premium content which may incur an additional charge to the user.

If the user incurs a charge for using the customizable card template at block 426, then a payment window is presented at block 428 before processing continues to block 430 where the customized card is output. The payment window can be any suitable payment mechanism, including using credits or by providing suitable billing information. In a configuration, PayPal or other electronic payment systems can be used. Payment can be used to pay for a particular customizable card, for premium content added with the card, or for putting value on a redeemable gift card. Once payment is confirmed, or if no payment is required, then at block 430 the customized card can be output from the MFP as desired by the user. For example, the user can print out a customized greeting card to be given in person to a friend or colleague. In another example, the user can print out a gift card or certificate to which value has been added. In another example, the user can fax the customized card to the recipient. In another example, the user can email a customized card or customized gift card to the intended recipient. In another example, various social media services can be utilized, including but not limited to sending a text message, a multi-media message, tweeting on TWITTER, or posting to FACEBOOK, INSTAGRAM, or SNAPCHAT among other suitable social media platforms. In these examples, the customized greeting card can be first rendered into an electronic file format suitable for social media service. For example, the customized greeting card can be rendered into a jpeg file, a gif file, or a portable document format (PDF) file, among other suitable file formats. After the customized card has been output in block 430, processing returns to block 408 to allow newer updated customizable cards to be loaded into the MFP.

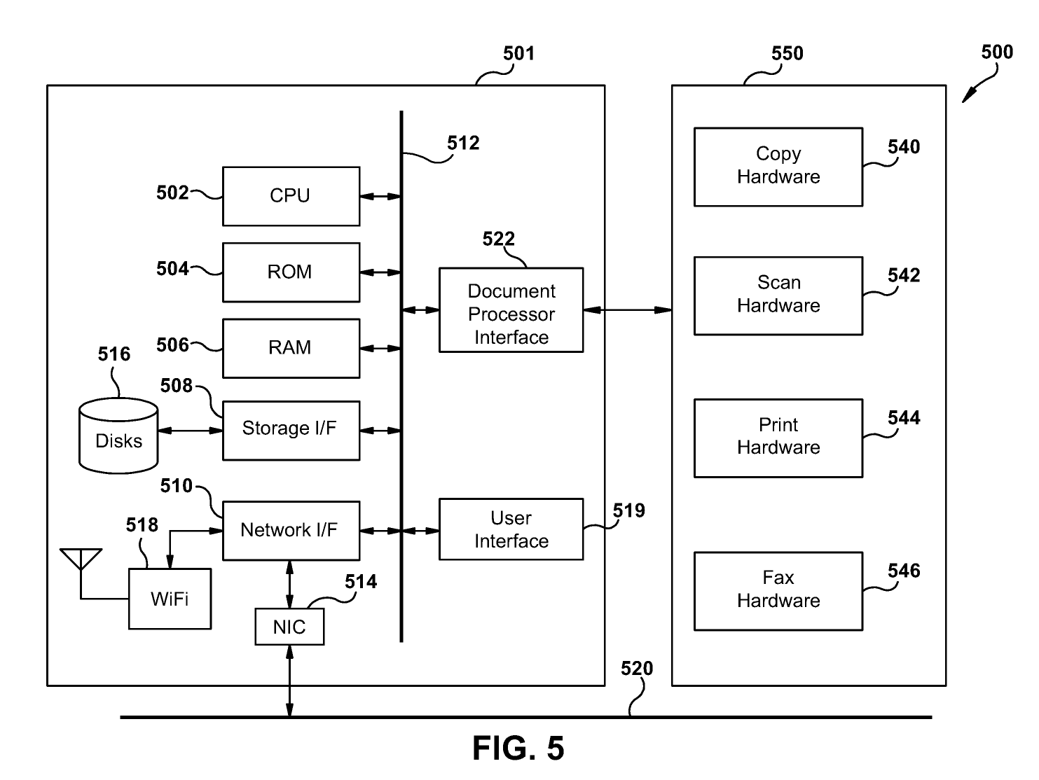

Turning now to FIG. 5 illustrated is an example embodiment of a networked digital device comprised of document rendering system 500 suitably comprised within an MFP, such as with MFP 104 of FIG. 1. Included in controller 501 are one or more processors, such as that illustrated by processor 502. Each processor is suitably associated with non-volatile memory, such as ROM 504, and random access memory (RAM) 506, via a data bus 512.

Processor 502 is also in data communication with a storage interface 508 for reading or writing to a storage 516, suitably comprised of a hard disk, optical disk, solid-state disk, cloud-based storage, or any other suitable data storage as will be appreciated by one of ordinary skill in the art.

Processor 502 is also in data communication with a network interface 510 which provides an interface to a network interface controller (NIC) 514, which in turn provides a data path to any suitable wired or physical network connection 520, or to a wireless data connection via wireless network interface 518. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 502 is also in data communication with one or more sensors which provide data relative to a state of the device or associated surroundings, such as device temperature, ambient temperature, humidity, device movement and the like.

Processor 502 can also be in data communication with any suitable user input/output (I/O) interface 519 which provides data communication with user peripherals, such as displays, keyboards, mice, track balls, touchscreens, or the like.

Also in data communication with data bus 512 is a document processor interface 522 suitable for data communication with MFP functional units 550. In the illustrate example, these units include copy hardware 540, scan hardware 542, print hardware 544 and fax hardware 546 which together comprise MFP functional hardware 750. Hardware monitors suitably provide device event data, working in concert with suitable monitoring systems. By way of further example, monitoring systems may include page counters, sensor output, such as consumable level sensors, temperature sensors, power quality sensors, device error sensors, door open sensors, and the like. It will be understood that functional units are suitably comprised of intelligent units, including any suitable hardware or software platform.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A document processing system comprising:
a document processing engine configured to render printed output from electronic image files;
a network interface configured to receive one or more card templates from an associated template server;
a touchscreen user interface configured to receive user input for customizing a user selected card template; and
an intelligent controller including a processor and memory,
the controller configured for controlled operation of the document processing engine,
the memory configured to store the received card templates,
the processor configured to generate an electronic image of a customized card in accordance with the user selected card template and the received user input, and
the processor configured to output the customized card in accordance with user device control instructions.

2. The document processing system of claim 1 wherein the user device control instructions include an instruction to print a tangible copy of the customized card via a print unit associated with the document processing engine.

3. The document processing system of claim 1 wherein the device control instructions include an instruction to electronically transmit the customized card via the network interface.

4. The document processing system of claim 3 wherein the processor is further configured to generate, from the electronic image of the customized card, an electronic file selected from the group consisting of a jpeg file, a gif file, and a portable document format file, and
wherein the electronic file is electronically transmitted using a social networking service selected from the group consisting of an instant message, an email message, and a post on a social media site.

5. The document processing system of claim 1 wherein the user interface is further configured to receive payment information from the user, wherein the network interface is further configured to process a payment with an electronic payment system using the payment information, and wherein the processor is further configured to enable the output of the customized card only upon successful processing of the payment with the electronic payment system.

6. The document processing system of claim 5 wherein the processor is further configured to customize the electronic image of the customized card based at least in part on the payment with the electronic payment system.

7. The document processing system of claim 1 wherein the network interface is further configured to send, to the associated template server, culture identifying information selected from the group consisting of a local time and date of the document processing system, an internet protocol address associated with the document processing system, a geographical region associated with the document processing system, and culturally relevant information associated with one or more users of the document processing system, and
wherein the associated template server is configured to determine, based at least in part on the received culture identifying information, one or more culturally appropriate card templates to transmit to the document processing.

8. The document processing system of claim 1 wherein the received user input for customizing the user selected card template is selected from the group consisting of a recipients name, a recipient's email address, a recipient's mailing address, a personalized message, and a selection of premium content.

9. A method comprising:
receiving, via a network interface of a multifunction peripheral, one or more customizable card templates from an associated card template server;
storing, in memory of a controller of the multifunction peripheral, the received customizable card templates;
receiving, via a touchscreen user interface of the multifunction peripheral, a user input for customizing a selected card template;
generating, by a processor of the controller, a customized card in accordance with the selected card template and the received user input;
outputting, via an operation of the multifunction peripheral, the customized card in accordance with a user device control instruction.

10. The method of claim 9 wherein outputting includes printing a tangible copy of the customized card via an associated print unit of the multifunction peripheral.

11. The method of claim 9 wherein outputting includes electronically transmitting the customized card via the network interface.

12. The method of claim 11 wherein the customized card is electronically transmitted using a social networking service selected from the group consisting of an instant message, an email message, and a post on a social media site.

13. The method of claim 9 further comprising:
receiving, via the touchscreen user interface, user payment information;
processing a payment, via the network interface, with an electronic payment system using the payment information; and
disabling, by the processor, the outputting of the customized card until the payment is successfully processed with the electronic payment system.

14. The method of claim 13 further comprising:
customizing, by the processor, the electronic image of the customized card based at least in part on the payment with the electronic payment system.

15. The method of claim 9 further comprising:
sending, via the network interface and to the associated card template server, culture identifying information; and
determining, by the associated card template server, one or more culturally appropriate card templates to transmit to the multifunction peripheral based at least in part on the received culture identifying information.

16. The method of claim 15 wherein the culture identifying information is selected from the group consisting of a local time and date of the multifunction peripheral, an internet protocol address associated with the multifunction peripheral, a geographical region associated with the multifunction peripheral, and culturally relevant information associated with one or more users of the multifunction peripheral.

17. The method of claim 9 wherein the user input for customizing the selected card template is selected from the group consisting of a recipients name, a recipient's email address, a recipient's mailing address, a personalized message, and a selection of premium content.

18. The method of claim 9 further comprising:
displaying, on the touchscreen user interface of the multifunction peripheral, at least a subset of the received customizable card templates; and
receiving, via the touchscreen user interface of the multifunction peripheral, a user input for selecting the selected card template from the displayed customizable card templates.

19. A system comprising:
a card template server configured to
receive identifying information from each of one or more multifunction peripherals, and
send culturally relevant customizable card templates to each multifunction peripheral based on the received identifying information; and
a multifunction peripheral further comprising
a document processing engine configured to render printed output from electronic image files,
a touchscreen user interface configured to
display one or more customizable card templates, and
receive user input for selecting and customizing a selected card template, and
an intelligent controller including a processor and memory,
the memory configured to store the received customizable card templates, and
the processor configured to
generate an electronic image of a customized card in accordance with the selected card template and at least a portion of the received user input, and
selectively control operation of the document processing engine to print the electronic image of the customized card.

20. The system of claim 19 wherein the processor is further configured to generate an electronic file of the customized card selected from the group consisting of a jpeg file, a gif file, and a portable document format file, and
wherein the processor is further configured to electronically transmit the electronic file using a social networking service selected from the group consisting of an instant message, an email message, and a post on a social media site.
